(19) United States
(12) Patent Application Publication
(10) Pub. No.: US 2012/0297627 A1
(43) Pub. Date: Nov. 29, 2012

(54) PIPE CUTTER

(76) Inventor: Roderic Henry VINCE, Buderim (AU)

(21) Appl. No.: 13/571,536

(22) Filed: Aug. 10, 2012

Related U.S. Application Data
(63) Continuation-in-part of application No. 12/089,041, filed on Sep. 10, 2008.

(30) Foreign Application Priority Data
Oct. 6, 2005 (AU) 2005905609

(51) Int. Cl. B23D 21/14

(52) U.S. Cl. 30/103

(57) ABSTRACT

A mechanical pipe cutting device comprising of a shaft body with a tapered spring loaded internal drive shaft, with interchangeable heads of varying sizes. The sole purpose of the tool is to cut pipes of different sizes from within. Each head has multiple spring loaded blades that are forced outwards by downward pressure. The shaft body has an adjustable depth guide so that the downward pressure of the operator forces the spring loaded tapered drive shaft against the pistons holding the spring loaded cutters. This is all driven by some form of rotational motive power. As downward pressure is applied the cutters are forced into the surrounding pipe. On cutting through the downward pressure is released, the blades retract. The tool is ready to be extracted from the inside of the pipe.

### CROSS REFERENCE TO RELATED APPLICATIONS

This application is a continuation-in-part of U.S. application Ser. No. 12/089,041, which was the National Stage of International Application No. PCT/AU2006/001454, filed Oct. 6, 2006, which claims priority to Australian provisional patent application No. AU2005905609, filed Oct. 6, 2005, all of which are incorporated by reference herein.

### FIELD OF INVENTION

This invention relates to cutting all types of pipe, and in particular to cutting these pipes in restricted areas.

1. Background Art

There are occasions when a pipe needs to be cut when it is either closely adjacent a surface through which it passes or even below the surface at which it is located and it has been conventionally effectively impossible to do this or, at least to do it neatly and without likely damage to the surface or surround and then incurs reparation works.

An object of the invention is provide a means whereby a pipe can be cut from the interior thereof so that the actual location of the pipe is not of relevance as far as being able to cut the pipe.

2. Disclosure of the Invention

The invention, in its broad sense, includes a tool for cutting a pipe from the inside which includes an elongate body to which there is fitted a cutter heads having a number of cutters which are moveable radially and means whereby the cutters can be forced to move radially outwardly on being contacted by a drive rod.

In a preferred form of invention the drive rod is connected to a source of rotating power and is in itself driveably connected to the tubular body so that on rotation of the power source the body and the cutter head are caused to rotate, the arrangement being such that during such rotation an inward force on the rod causes the outward movement of the cutters.

It is preferred that there is an adjustment plate moveable along the body and retainable in required positions therealong which can act against an outer surface of the pipe being cut which provides an accurate spacing of the cut from the external surface of the pipe and a restraining means against the inward source can act.

### BRIEF DESCRIPTION OF THE DRAWINGS

In order that the invention can be more readily understood one particular embodiment of the pipe cutter is described with reference to the accompanying drawings, in which:

FIG. 1 is a part-sectional side view of a pipe cutter according to the invention;

FIG. 2 is a sectional view of a cutter head for the pipe cutter of FIG. 1;

FIG. 3 is a sectional view of the cutter head for the pipe cutter of FIG. 1, the section being orthogonal to that of FIG. 2;

FIG. 4 is a side view partly cut away of a driving rod for the pipe cutter of FIG. 1;

FIG. 5 is a side view, partly cut away, showing the assembly of the cutter head of FIGS. 2 and 3 attached to the driving rod of FIG. 4.

FIG. 6 is a pictorial, diametrical section of the pipe cutter of FIG. 1

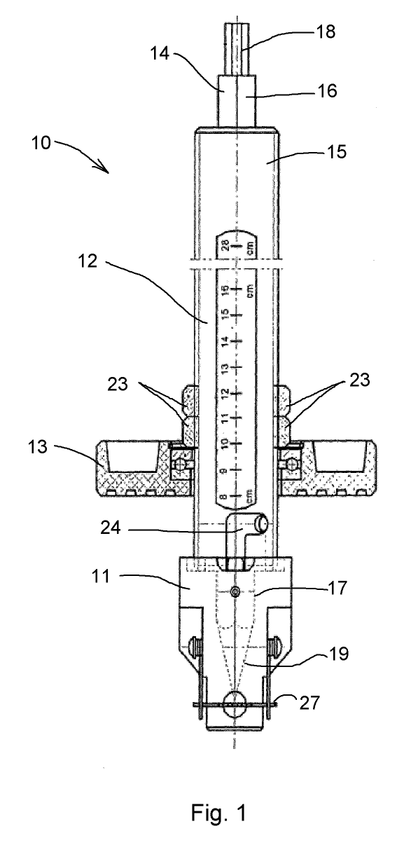

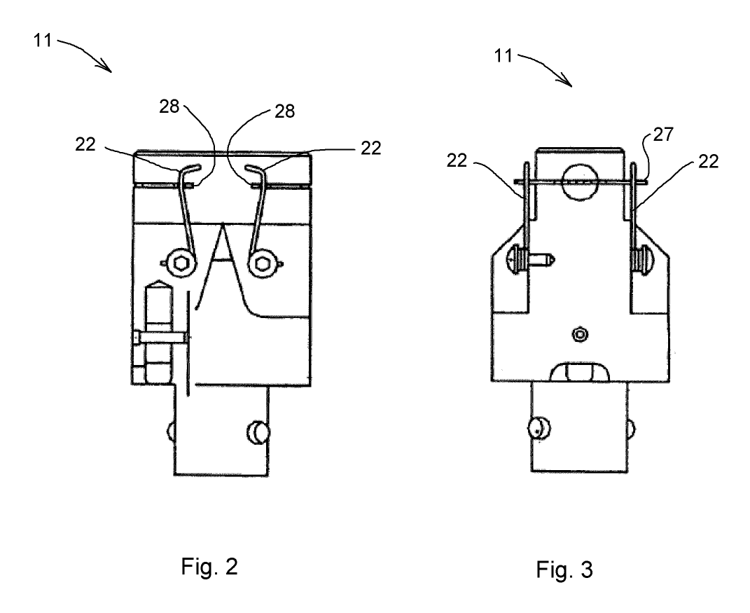

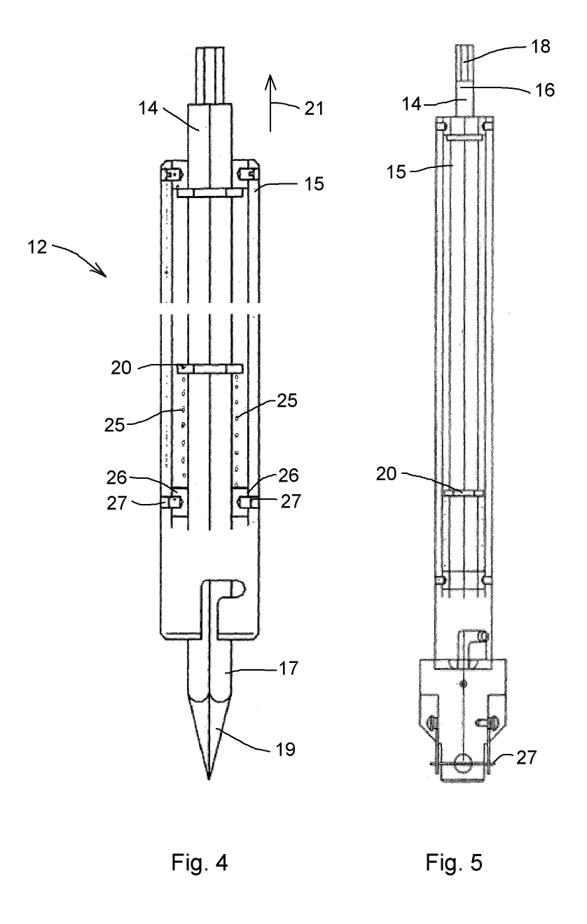

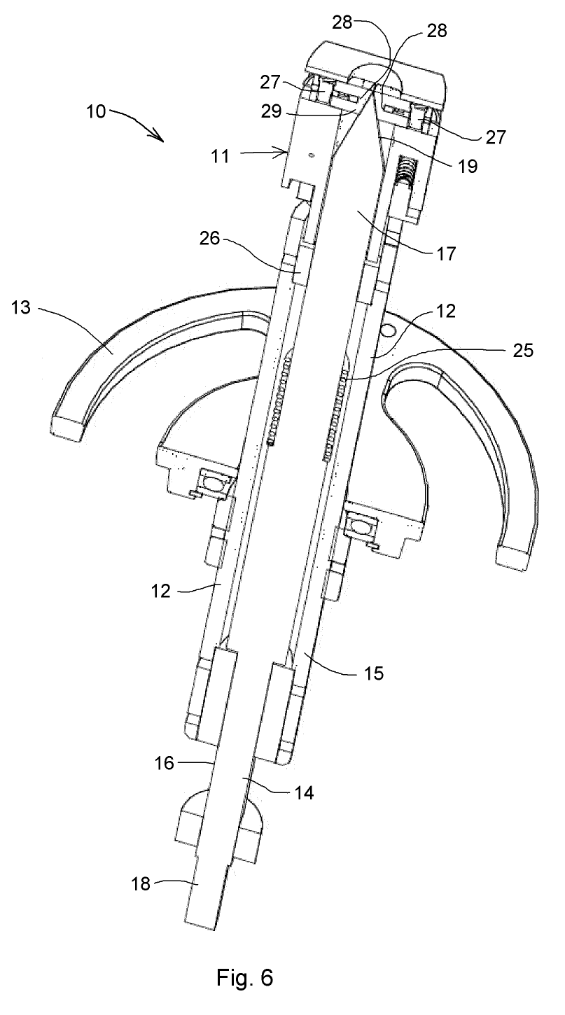

### DETAILED DESCRIPTION OF THE DRAWINGS

The pipe cutter 10 has a cutter head 11 attached to the end of a drive shaft 12 and a pushing plate 13 penetrated by a driving rod 14. While the dimensions of the cutter head 11 are not critical to the invention, it is necessary that the diameter of each cutter head be less than the internal diameter of the smallest pipe in respect of which it is to be used.

The driving rod 14 passes through a tube 15 and is located, preferably, at least adjacent each end thereof. The driving rod 14 extends outwardly from the ends of the tube 15 to provide projected portions 16 and 17. The projected portion at 16 includes a power connection formation 18 which may be connected to a power source, such as a power drill.

For convenience, the end of the driving rod 14 at the power connection formation will be referred to as the power connection end. The driving rod 14 is square in section, but may be otherwise shaped in cross section and has a tapered free end 19 on the projected portion at 17. The power connection end and free end terminology will likewise refer to the corresponding ends of the tube 15.

A washer 20 is fixed on the driving rod 14 spaced from the free end of the tube 15, which washer 20 is adapted to act as a stop for a helical spring 25, the other end of which can react against one of a location member 26 which is connected to the tube 15 so that the driving rod 14, in its rest position, is directed outwardly relative to the tube 15 in the direction of arrow 21 but can be moved axially within the limits of movements provided by the spring 25.

Connected to the lower end of the tube 15 there is the cutter head 11 which has a number of cutters 27 (minimum of two) preferably four which are radially located in the body which have cutting surfaces on their outer edges and which are spring biased by cutter head springs 22 to be normally within the periphery of the cutter head. At this position the cutters 27 each have inner ends spaced from one another by a distance which enables them to cooperate with the tapered end 19 of the driving rod 14 and to be moved outwardly against their spring bias when the driving rod 14 is moved axially relative to inner ends 28 of the cutters.

That is, as the driving rod 14 is moved downwardly in the tube 15 the tapered end 19 enters the space 29 bounded by the cutters 27 and on further downward movement the cutters 27 move outwardly beyond the periphery of the cutter head 11 and, provided the cutter head 11 is rotating whilst the outward pressure is being applied, the cutters 27 can cut off the pipe internally in which the cutter head 11 is located.

The pushing plate 13 is located around the tube 15 and is adapted to be moved along the tube and locked in to position by locking rings 23 which may be threadably connected to a thread on the outside of the tube 15 whereby the location of the pushing plate 13 along the length of the tube 15 can be selected and locked in place.

The operation of the pushing plate is that the required cutter head 11 is attached to the tube 15, by a bayonet fitting 24 thereon and the position of the cut is ascertained from the end of the pipe which is to be cut and the locking ring 24 is located upon the tube at a position so that the pushing plate 13 associated with this contacts the outer end of the pipe at the required distance therealong.

A drill is then connected to the power connection end of the driving rod 14 and, on rotation of the drill, the driving rod 14, the tube 15 and the pushing plate rotate 13 together, because of the shape of the shaft coacting with the apertures in the location members fixed to the tube. An inward pressure on the driving rod 14 (against the direction of arrow 21) causes the shaft to move axially relative to the rotating tube 15, whereby the tapered end 19 of the driving rod 14 enters the space between the cutters 27 and causes the cutters 27 to be moved outwardly. The outward movement can continue with further downward pressure on the driving shaft 14 until the pipe is cut. When the rotation of the drill ceases then the rotation of the tube 15 and the cutter head 11 also ceases and as the inward pressure by the drill is removed the driving rod 14 is moved back by its spring 25, the tapered end 19 moves from the position between the cutters 27, and the cutters retract via the cutter springs 22 and are retained within the cutter head 11.

It will be seen that the pipe cutter of the invention enables a quick and efficient means of cutting pipes from the interior thereof so that there is no part of the cutting mechanism, except ultimately the tips of the cutters which extend beyond the pipe to be cut and as such there is no likelihood of damage. There are occasions when a pipe needs to be cut when it is either closely adjacent a surface through which it passes or even below the surface at which it is located and it has been conventionally effectively impossible to do this or, at to do it neatly and without likely damage to the surface or surround. If it is required to cut off a pipe below a surface this can readily be achieved in a neat and workman like manner without requiring reparation work.

What is claimed is:

1. An internal pipe cutter for cutting a pipe from an interior surface of the pipe in an outward direction, comprising:
a body adapted at one end for releasable attachment to a cutter head;
a cutter connected to said cutter head, said cutter mounted for movement towards said interior surface for cutting said pipe; and
a driving member within, and operably connected to, said body for rotation with said body, said driving member having a tapered end engageable with said cutter whereby an outward force may be applied to said cutter when an inward pressure is applied to one end of said driving member sufficient to engage and subsequently maintain said cutter against said interior surface until said pipe is cut through.

2. The internal pipe cutter according to claim 1, wherein said driving member is adapted to enter centrally between two or more of said cutters when said pressure is applied to urge said cutters against said interior surface.

3. The internal pipe cutter according to claim 2, wherein there are two of said cutters.

4. The internal pipe cutter according to claim 1, further comprising a plate held in a required position on said body.
